(19) United States
(12) Patent Application Publication
(10) Pub. No.: US 2026/0228362 A1
(43) Pub. Date: Aug. 6, 2026

(54) SYSTEMS AND METHODS FOR ENHANCED SECRETS MANAGER USING GENERATIVE AI

(71) Applicant: JPMORGAN CHASE BANK, N.A., New York, NY (US)

(72) Inventors: Aditya LAD, Santa Clara, CA (US); Fei CHEN, Plano, TX (US); Jisoo HAN, Milpitas, CA (US); Roopa Hiremath CHANDRASEKARAIAH, Milpitas, CA (US)

(21) Appl. No.: 19/045,440

(22) Filed: Feb. 4, 2025

(51) Int. Cl. G06F 21/62; G06F 21/50

(52) U.S. Cl. CPC G06F 21/6254; G06F 21/50

(57) ABSTRACT

In some embodiments, the techniques described herein relate to a method including: reading, by a generative artificial intelligence (AI) agent executed by one or more processors, a property file including one or more current configurations of a configurable environment, the property file comprising one or more text entries describing an application of the configurable environment and one or more related secret entities; identifying, by the generative artificial intelligence (AI) agent, changes to the one or more current configurations; and implementing the identified changes.

### BACKGROUND

### 1. Field of The Invention

Aspects generally relate to systems and methods for an enhanced secrets manager.

### 2. Description of the Related Art

Protected information is vital to many institutions in the management of internal corporate information, personal identifiable information, trade secrets, credentials, private and public keys for encrypting or decrypting information, authentication tokens, application programming interface (“API”) keys, and sensitive or private configuration properties. This protected information has far-reaching effects including on institution's function, purpose, and ability to operate computer systems. The protection of this information is thus vital to ensure continued operation of computer systems and the institutions'regular functions. Current protection systems are unable to manage protected information from different sources when it is formatted in unknown or unexpected ways. Current protection systems are also unable to dynamically update and manage configuration files based on runtime environment and service prefixes in an efficient or complete way. Current systems are also reliant on manual expertise including human operation that can include errors and inefficiencies. Such errors can lead to misconfigurations and security vulnerabilities. It is desired for an improved secret management process and system that is safe, robust, scalable, efficient and requires no or minimal human operation.

### SUMMARY

Exemplary embodiments provide systems and methods for an enhanced secrets manager using generative artificial intelligence. According to one embodiment, a method may include: reading, by a generative artificial intelligence (AI) agent executed by one or more processors, a property file including one or more current configurations of a configurable environment, the property file comprising one or more text entries describing multiple applications of the configurable environment and one or more related secret entities, wherein the property file includes an incorrect spelling or incorrect punctuation; analyzing, by the generative AI agent, a configuration parameter relationship based on the property file and the configuration parameter's relationship on the application; determining, by the generative AI agent, a contention between resources of the multiple applications of the configurable environment based on the configuration parameter's relationship as compared to test-case configuration parameter's relationships of past configurations; querying, by the generative AI agent, a large language model (LLM) for a prefix identification; constructing, by the generative AI agent, a resource name including the prefix identification, an application name, and one of the one or more related secret entities; and integrating, by the generative AI agent, the resource name into a configuration setting of the property file.

In some embodiments, the method may further comprise scanning the application for personal identifiable information including a password and masking the personal identifiable information. In some embodiments, the method may further comprise scanning the application for personal identifiable information including an API key and masking the personal identifiable information. In some embodiments, the method may further comprise updating the property file with the masked personal identifiable information. In some embodiments, the method may further comprise triggering a secrets manager to initiate a multithreaded secret fetch and performing an expiration check on one or more secrets returned from the multithreaded secret fetch. In some embodiments, the method may further comprise triggering a secrets manager to initiate a multithreaded secret fetch and performing an integrity validation on one or more secrets returned from the multithreaded secret fetch. In some embodiments, the method may further comprise storing the one or more secrets on a secure database once integrity is validated.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for an enhanced secrets manager, in accordance with embodiments.

FIG. 2 is a method for an enhanced secrets manager, in accordance with embodiments.

FIG. 3 is a method for an enhanced secrets manager, in accordance with embodiments.

FIG. 4 is a block diagram of a computing device for implementing certain aspects of the present disclosure.

### DETAILED DESCRIPTION

Aspects generally relate to systems and methods for generating a merchant trust score.

Disclosed are systems and methods including receiving, from an application in operable communication with a user interface, an indication to start or initialize a generative AI agent. The indication may be based on an event. The generative AI agent may contain one or more containerized microservices. The generative AI agent may read a property file including one or more current configurations of a configurable environment. The generative AI agent may include an AI driven analysis including contention between resources and/or security vulnerabilities. The generative AI agent may provide historical data to a machine learning engine, the historical data including past configurations. The machine learning engine may be trained on the past configurations. The application may be configured to query the machine learning engine for a prefix identification. The machine learning engine may provide one or more identified prefixes to the general AI agent. The generative AI agent may generate a smart name, unique in its namespace. The generative AI agent may update a configuration of the configurable environment with the generated smart names.

The generative AI agent may scan for secret information including personal identifiable information, passwords, API keys, or other secret or encrypted information. The generative AI agent may apply encryption to, hash, or mask the secret information. The generative AI agent may apply a compliance rule. The generative AI agent may update a property file of the configurable environment with the applied encryption, hash, or mask. The generative AI agent may next analyze adaptive context loading through a spring boot agent (e.g., through a Java® framework spring boot agent). The spring boot module may invoke a post processor of a secrets manager. The secrets manager may, upon initialization, initiate a multithreaded secret fetch from a secrets manager service. The secret fetch may enhance efficiency. The secrets manager service may fetch secrets from a cloud secret manager and/or a local secret manager, in the agnostic manner. The secrets manager may validate a secret integrity based on integrity and/or expiration. The secrets manager may provide alerts to one or more user interfaces such as an administrator console or observability dashboard, including issue detection and/or proactive alerts.

The secrets manager may store one or more of the secrets securely in the configurable environment. The configurable environment may encrypt the secrets, when secrets are stored in storage medium (e.g. disk drive or cloud storage). The configurable environment may log access and changes to the secrets. The configurable environment may track access patterns including insert, update, deletion. The application may retrieve the secrets from the configurable environment.

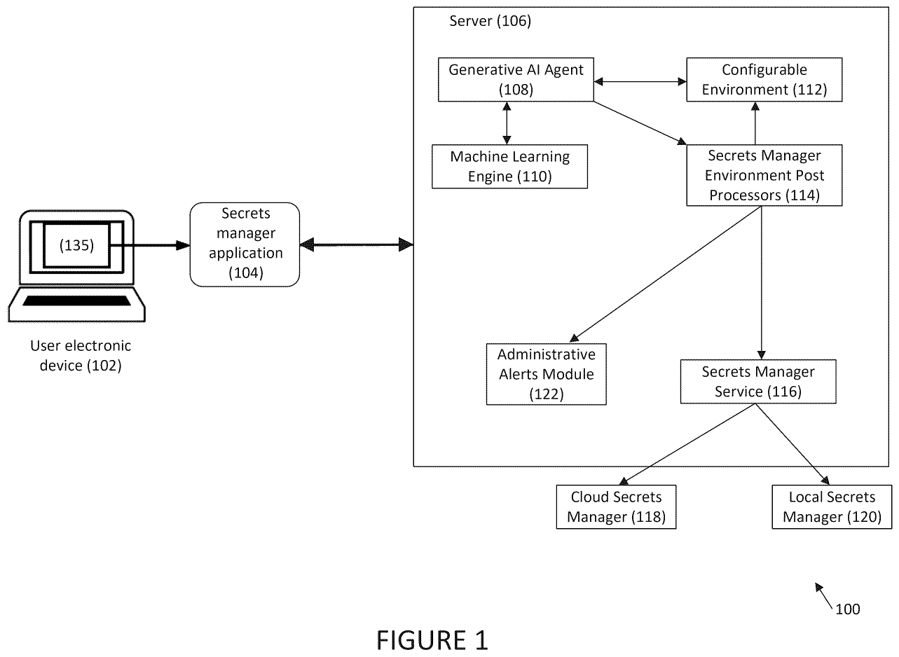

FIG. 1 is a block diagram of a system for identity proofing, in accordance with embodiments.

System 100 includes a user electronic device 102 executing a secrets manager application 104 available through a user interface 135, a server 106 comprising a network or computer including a processor executing one or more software modules and a memory space for storing data accessible by the one or more software modules and instructions to execute the one or more software modules. The one or more software modules may include one or more of a generative artificial intelligence (AI) agent 108, a machine learning engine 110, a configurable environment 112, a secrets manager environment post processor 114, an administrative alerts module 122, and a secrets manager service 116.

In some embodiments, a cloud secrets manager 118 and/or a local secrets manager 120 may be accessible by the one or more software modules and may be a part of a cloud network and a local network respectively. The cloud secrets manager 118 and/or the local secrets manager 120 may be software modules executed by one or more processors as part of a cloud network and a local network respectively.

The server 106 may be a server. The server may be part of an institution backend. The server may be part of a cloud-based server. The server may be a computer, a cluster, a physical machine, a virtual machine, a container. In some embodiments, the server 106 may include one or more databases referenced by one or more of the software modules.

In accordance with aspects, user electronic device 102 may be a user electronic device such as a personal communication device (e.g., tablet, phone), computer workstation, laptop, in the form of physical or virtual, or other electronic processing device in operative communication with secrets manager application 104 and/or server 106. User electronic device 102 may be configured to interact with score service application 104 through user interface 135. For instance, user device 102 may include a client application that allows a user of user electronic device 102 to interact with score service application 104. User interface 135 may include one or more graphical user interfaces to receive inputs and/or display information to the user. User interface 135 and/or score service application 104 may comprise one or more instructions executed by one or more processors of user electronic device 102. Secrets manager application 104 may be a software production application provided by a service organization. In an exemplary aspect, secrets manager application 104 may be an environment management application or system, or a platform service.

In some embodiments, secrets manager application 104 may include an application programming interface (“API”) request (e.g., function call or method request) to communicate with server 106 to manage secrets of a target configurable environment 112. The target configurable environment 112 may be a part of or be a private cloud, a public cloud, or a hybrid cloud. In some embodiments, secret manager application 104 may respond to an API call with access to particular secrets, confirmation of secrets implementations, and/or deployment of the target configurable environment 112 with one or more compliance rules and/or secrets implementations as discussed further herein. The secrets manager application 104 may check an environment periodically or be event-driven (e.g., such as a process or data change based on a user instruction, an updated compliance rule, an implementation of a new compliance rule).

In some embodiments, generative AI agent 108 may be a software program which can take text input, process the text, execute tasks, and generate responses. The generative AI agent 108 may adapt to the environment by learning from previous startup patterns and optimizing initialization time. The generative AI agent may be deployed as a containerized microservice, allowing for independent scaling and fault tolerance, ensuring high availability and resilience.

In some embodiments, generative AI agent 108 may read the text content of a property file of a target configurable environment 112. The property file may contain an initial configuration settings template (e.g. namespace, api_key, secret_name, database configuration, environmental variables). The initial configuration settings may be related to the application of the target configurable environment 112.

In some embodiments, generative AI agent 108 may analyze the property file by invoking an API interface to connect to foundation models and retrieve contextual responses. Generative AI agent 108 may communicate with a large language model (“LLM”) or machine learning engine 110 to generate the analysis and runtime response based on initial configuration settings combined with a prompt template. Machine learning engine 110 may conduct a contextual analysis including understanding the initial configuration setting, to understand the intended purpose and how they relate to overall application and environment. Machine learning engine 110 may conduct an impact assessment to assess the impact of any changes to property file on the target configuration, applications. This involves predicting how modifications might affect application behavior, performance, security or compatibility. Machine learning engine 110 may conduct error detection and resolution to identify potential errors or misconfigurations in the property file, provide insights and recommendation how to resolve them.

Generative AI agent 108 may determine differences between a foundation model and the property file based on the contextual responses. Generative AI agent 108 may determine an effect of a change to the property file on the target configurable environment 112 and its application.

In some embodiments, generative AI agent 108 may predict one or more configuration conflicts based on the current settings and application (e.g., a context related to the application) of the target configurable environment 112. Generative AI agent 108 may communicate with a large language model (“LLM”) or machine learning engine 110 to generate the prediction based on a single predicted value response of a secret entity. The secret entity may be a sensitive piece of information included in the configuration settings. The secret entity may include one or more items such as passwords, API keys, personal identifiable information, encryption keys, and any other confidential data that requires protection from unauthorized access. Generative AI agent 108 may be tasked with generating predictions and recommendations for optimizing or correcting these configuration settings, which include managing these secret entities securely. Generative AI agent 108 may generate recommendations and insights for AI agent which may generate recommendations for optimizing or correcting the configuration settings. This could include suggesting changes to align with best practices, improve performance, or enhance security.

Generative AI agent 108 may further determine and apply, based on the generated secret entity, for resource contention, incompatible settings, and/or security vulnerabilities. For a cloud-based application that uses several microservices, each requiring access to different databases and APIs, each microservice may need to authenticate using API keys and database credentials, where one or more of the database credentials may be a secret entity.

For example, Generative AI agent 108 may suggest changes to align with best practices including analyzing the current configuration and notice that API keys are hardcoded directly into the application's source code. Generative AI agent 108 may, upon determining best practice, recommend to or move these keys to a secure secrets manager service, such as a secrets manager or vault, to prevent secret exposure in version control systems.

As another example, Generative AI agent 108 may suggest changes to improve performance such as detecting that the application is fetching secrets from the secrets manager service synchronously at runtime, which could introduce latency. Generative AI agent 108 may, upon determining best practice, recommend to or cache the secrets securely in memory (depending on the application type) after the first fetch to reduce the number of calls to the secrets manager and thus improve application performance.

As another example, Generative AI agent 108 may identify that some secrets, like database passwords, are not being rotated regularly. Generative AI agent 108 may, upon determining best practice, recommend to or automate a secret rotation policy to minimize the risk of credential compromise.

As another example, regarding resource contention, Generative AI agent 108 may detect that multiple services are trying to access the same secret simultaneously, leading to bottlenecks. Generative AI agent 108 may, upon determining best practice, recommend to or implement a more efficient access pattern or increase the throughput capacity of the secrets manager service.

As another example, regarding incompatible settings, Generative AI agent 108 may find that a particular secret is configured with an encryption algorithm that is not supported by one of the services using it. Generative AI agent 108 may, upon determining best practice, recommend to or update the encryption settings to ensure compatibility across all services.

As another example, regarding security vulnerabilities, Generative AI agent 108 may discover that a secret is being transmitted over an unencrypted channel, it could recommend configuring the application to use HTTPS or another secure protocol to protect the data in transit. By analyzing the configuration and usage patterns of these secret entities, the Generative AI agent 108 may provide actionable insights and recommendations to optimize the application's security and performance while ensuring compliance with best practices and/or may implement the changes to the application's security and enforce compliance.

In some embodiments, generative AI agent 108 may generate recommendation of an optimal service configuration. Generative AI agent 108 may communicate with a large language model (“LLM”) or machine learning engine 110 to generate the optimal service configuration based on historical data and/or usage patterns of one or more model service configurations. In some embodiments, the LLM or machine learning engine may consider feedback of one or more improvements of usage patterns to track whether a change created a positive effect on the one or more model service configurations. In some embodiments, the recommendations may be based on the feedback loop to enhance performance and/or cost effectiveness of the target configurable environment 112.

In some embodiments, generative AI agent 108 may log inputs, workflows, and/or outputs including reasoning in a series of steps that may be easily reviewable, auditable, traceable by an AI model administrator or a user. In some embodiments, generative AI agent 108 may rollback an implementation of the recommendation or configuration change based on a user input, a determination of a configuration error or failure from the function output. In some embodiments, feedback associated with the rollback and the specific step related to the configuration error or failure, the specific step being of the series of steps, may be provided to the machine learning engine for training and/or generation of configuration recommendations.

In some embodiments, generative AI agent 108 may initialize machine learning engine 110 to identify one or more service prefixes within the property file. The service prefix may identify a program such as AWS®, Microsoft®, or local. The machine learning engine 110 may, for identified service prefixes, construct a resource name. The resource name may, for example, generate an identified service prefix of “program-secret1,” generate a resource name of “name:program:prefix/application-name/program-secret1”. Once generated, generative AI agent 108 may determine whether the updated resource name will operate with the target configurable environment 112. If successful, generative AI agent 108 may integrate the updated resource name into a configuration file. The generative AI agent 108 may check before and after integration to ensure accurate resource referencing.

In some embodiments, generative AI agent 108 may scan configurable environment 112 for secret information including personal identifiable information, passwords, API keys, or other secret or encrypted information. Generative AI agent 112 may apply encryption to, hash, or mask the secret information. Generative AI agent 112 may apply a compliance rule. Generative AI agent 112 may update a property file of the configurable environment with the applied encryption, hash, or mask.

Generative AI agent 112 may analyze adaptive context loading through a spring boot agent. The spring boot agent may be a Java® framework spring boot. The spring boot may initialize using critical configuration files based on application usage patterns, reducing startup time and resource consumption. The spring boot agent may invoke secrets manager environment post processor 114. Secrets manager environment post processor 114 may, upon initialization, initiate a multithreaded secret fetch from secrets manager service 116. The secret fetch may enhance efficiency. The multithreaded secret fetch may initiate multiple threads to fetch secrets from the respective secrets stores (e.g., AWS Secrets Manager, Azure Key Vault, Local Vault) using generative AI agent 108 for one or more configuration settings as runtime context. This parallel processing approach enhances efficiency and reduces latency.

Secrets manager service 116 may fetch secrets from a cloud secret manager 118 and/or a local secret manager 120. The secrets manager may validate a secret integrity based on integrity and/or expiration. The secrets manager service 116 may validate the integrity of the fetched secrets to ensure they have not been tampered with or corrupted by comparing the fetched secrets against stored versions and/or model versions. The secrets manager service 116 the expiration dates of the secrets to ensure they are still valid and have not expired. The secrets manager service 116 may provide alerts to one or more user interfaces like user interface 135 or an administrator, the alerts including secrets expiration (current or imminent expiration), issue detection and/or proactive alerts.

Proactive alerts may include an Imminent Expiration Alert including notifying users or administrators when a secret is approaching its expiration date, allowing them to take action to renew or rotate the secret before it expires.

Proactive alerts may include an Integrity Check Failure Alert including alerting one or more users if a secret fails an integrity check, indicating that the secret may have been tampered with or corrupted. This allows for immediate investigation and remediation.

Proactive alerts may include an Usage Anomaly Alert including Detecting unusual patterns in secret access or usage, such as a sudden spike in access requests, which could indicate a potential security breach or misuse.

Proactive alerts may include an Secret Rotation Reminder including Reminding users to rotate secrets regularly as part of best practices for security, even if the secret has not yet expired.

Proactive alerts may include an Access Pattern Change Alert including notifying administrators of significant changes in access patterns, such as new users accessing a secret or access from unexpected locations, which could warrant further investigation.

Proactive alerts may include a Policy Compliance Alert including Alerting one or more users if a secret does not comply with organizational policies or standards, such as using weak encryption or not meeting complexity requirements.

Proactive alerts may include a Resource Utilization Alert including providing one or more notifications about the resource usage of the secrets manager service, such as reaching limits on the number of secrets stored or accessed, which could impact performance or incur additional costs.

Proactive alerts may include an Backup and Recovery Alert including reminding users to perform regular backups of secrets or alerts them if a scheduled backup fails, ensuring that secrets can be recovered in case of data loss.

The secrets manager service 116 may store one or more of the secrets securely in the configurable environment or the application context of the configurable environment. The configurable environment may encrypt the secrets, particularly if they are not in use (e.g., at rest). The configurable environment may log access and changes to the secrets. The configurable environment may track access patterns. The configurable environment may provide an audit trail that can be used to monitor and review the access patterns, which may help in identifying unauthorized access attempts, anomalies, and/or system errors. The system errors may be reported to the generative AI agent 108 for machine learning engine 110 training as discussed above.

In some embodiments, the secrets manager application 104 may retrieve the secrets from the configurable environment 112 when needed without additional overhead or latency. Secrets manager application 104 may thus allow efficient alert errors, machine learning training, and configuration recommendations and implementations without human intervention.

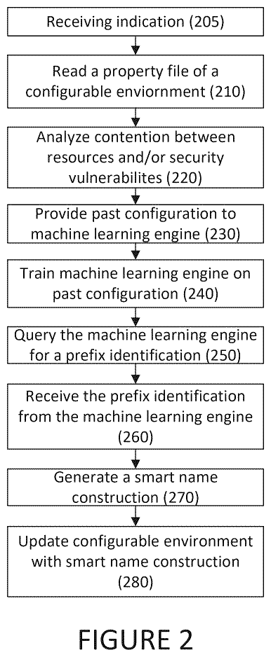

FIG. 2 is a method for an enhanced secrets manager, in accordance with some embodiments. The method may be stored as a list of instructions stored on a memory that when executed by one or more processors cause the one or more processors to perform the method.

Step 205 may include receiving, from an application in operable communication with a user interface, an indication to start or initialize a generative AI agent. The user interface here may be graphical user interface, a computer program, a process. The indication may be based on an event, a starting point. The generative AI agent may contain one or more containerized microservices. The generative AI agent may serve as an endpoint or an application programming interface. The user interface and AI agent may be allowed to communicate with each other by authentication mechanism. The data communication should be secure. The data sent and received may not be visible nor modifiable by any process or persons in the middle.

Step 210 may include, by the generative AI agent, reading a property file including one or more current configurations of a configurable environment. The configurable environment may be a namespace where an application or many applications run. The namespace may be a container that holds a grouping of unique identifiers. The namespace may be a directory. The property file may contain one or more text entries describing the application and related secret entities. The text entries may be descriptions of secret entity to be used by the application. The property file may not follow strict format rules because AI agent and large language models may understand the text. Understanding the text may occur by using large language model that includes one or more of determining semantically similar, phonetic matching, and one or more large language models that may include a bidirectional encoder representation and transformation. Often when strict format rules are used common issues of misspelling, incorrect spelling, case sensitive letters, incorrect punctuations may happen, which may result extra development time, operation overhead, incident mitigation. The mentioned issues may be addressed by the design provided here.

Step 220 may include, by the generative AI agent, analyzing contention between resources and/or security vulnerabilities. It is common to encounter failures in large scale distributed environments because of issues related to cloud service, networking, hardware, software, and constant changes. Managing, maintaining, operating application in large scale in reliable and resilient manner requires infrastructure to support and adapt surrounding environment in agile manner. By providing the property file and its descriptive text for secret entities, the generative AI agent may read the text, process the input along with rules defined in prompting templates, execute function calls, analyze response output, conduct evaluation or comparison, and generate optimized result. This may reduce configuration management and operation efforts for large scale distributed applications. The contention analysis may be conducted by using descriptive text, not prescriptive words. The generative AI agent may use its own output for result recommendations for better result, avoiding unnecessary work.

Step 230 may include, by the generative AI agent, providing historical data to a machine learning engine, the historical data including past configurations. AI agent may have the ability to use text or tags to label secret entities created, for example when it was created, used, error message, failure ratio. The AI agent may use these data as reference for future operations, to meet various secret rotation, data privacy, compliance rules. This design provides flexibility and control for applications which may have requirements of self-ownership of secret entities.

Step 240 may include, by the generative AI agent, training the machine learning engine on past configurations (e.g., model configurations). Past configurations, past usage data, past performance data may be collected, grouped, evaluated to enhance future AI agent performance. AI agent may make mistake, generate incorrect response, or repeat mistakes. Past configurations data may be used to trained to improve AI agent performance. The past configurations may be used to included in future model training, model fine-tuning, or text embeddings. Through the self-reinforcement learning loop AI agent may improve AI agent itself by following predefined policy or rules.

Step 250 may include, by the generative AI agent, querying the machine learning engine for a prefix identification. The individual prefix identification for secret entity can be an alphanumeric character string, or an encoded string derived from the alphanumeric character string, or even a calculated hash value from the alphanumeric character string. The prefix identification may be used by application to retrieve per-defined secrets. The prefix identification may be considered as the static secret configuration item in traditional computer programs. The static secret configuration item may be static, prescriptive, use strict format rules, difficult to maintain and operate. AI agent may automate this process, reduce human efforts, improve efficiency by the process combination of context description, text understanding, agent function call, prompting engineering and template, and feedback loop. The AI agent may be configurable or tunable to provide deterministic results when using same or similar text inputs. The prefix identification may be unique, identifiable, machine readable. The prefix identification may not be user friendly when data privacy or security compliance policies are in place.

Step 260 may include, by the machine learning engine, providing one or more identified prefixes to the general AI agent. The prefixes can be application name, business unit, location, identifier. The prefixes may be considered meta data or context for the secret entity. The individual prefix may be unique in its own namespace. The prefixes may be flexible to create, use, update. The prefix may be in the format of single word, a phrase, or a sentence. The prefix may be short or long. The prefix may be re-generated by AI agent if initial result does not meet technical or compliance requirement. The prefix may be part of prompt input to be used by AI agent for next response.

Step 270 may include, by the generative AI agent, generating a smart name. The name may be constructed as a string of token strings. Each token string is generated by AI agent, or the full combination of token strings. AI agent may generate a single value token or token strings. Prompt engineering technique of minimum temperature of zero, prompt template of enforcing single value output can be used or implemented. The name may be meant to be machine readable for data protection. The generated name may be deterministic through the life cycle of the secret entity.

Step 280 may include, by the generative AI agent, updating a configuration of the configurable environment with the generated smart names. The names may be generated using the combined data of initial configuration settings, runtime context, and input parameters. The properties of names may be non-static, dynamic, unique, recognizable by machine and programs. The generated names may have one to one mapping between input and output, to comply secret requirements.

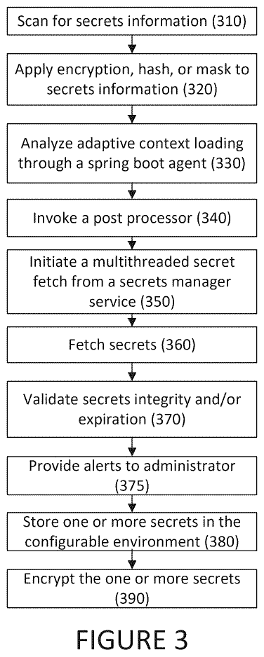

FIG. 3 is a method for an enhanced secrets manager, in accordance with some embodiments. The method may be stored as a list of instructions stored on a memory that when executed by one or more processors cause the one or more processors to perform the method.

Step 310 may include, by the generative AI agent, scanning the target configurable environment for secret information including personal identifiable information, passwords, API keys, or other secret or encrypted information.

Step 320 may include, by the generative AI agent, applying encryption to, hash, or mask the secret information. The generative AI agent may apply a compliance rule. Step 320 may include, by the generative AI agent, updating a property file of the configurable environment with the applied encryption, hash, or mask.

Step 330 may include, by the generative AI agent, analyzing adaptive context loading through a spring boot agent.

Step 340 may include, by the spring boot module, invoking a post processor of a secrets manager.

Step 350 may include, by the secrets manager, initiate a multithreaded secret fetch from a secrets manager service. The secret fetch may enhance efficiency.

Step 360 may include, by the secrets manager, fetch secrets from a cloud secret manager and/or a local secret manager.

Step 370 may include, by the secrets manager, validating a secret integrity based on integrity and/or expiration.

Step 375 may include, by the secrets manager, providing alerts to one or more user interfaces such as an administrator including issue detection and/or proactive alerts.

Step 380 may include, by the secrets manager, storing one or more of the secrets securely in the configurable environment.

Step 390 may include, by the configurable environment, encrypting the secrets. The secrets to be encrypted may be identified by the secrets manager based on if they are not in use (e.g., at rest). The configurable environment may log access and changes to the secrets. The configurable environment may track access patterns. The application may retrieve the secrets from the configurable environment.

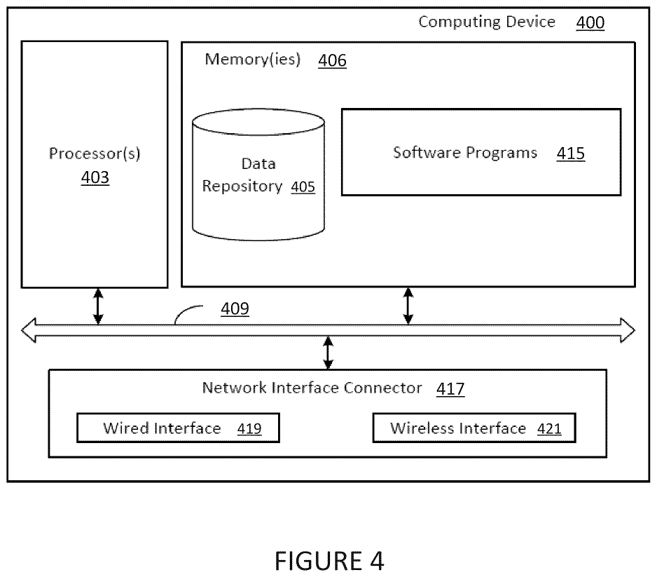

FIG. 4 is a block diagram of a computing device for implementing certain aspects of the present disclosure. FIG. 4 depicts exemplary computing device 400. Computing device 400 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 400.

Computing device 400 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
reading, by a generative artificial intelligence (AI) agent executed by one or more processors, a property file including one or more current configurations of a configurable environment, the property file comprising one or more text entries describing multiple applications of the configurable environment and one or more related secret entities, wherein the property file includes an incorrect spelling or incorrect punctuation;
analyzing, by the generative AI agent, a configuration parameter relationship based on the property file and the configuration parameter's relationship on the application;
determining, by the generative AI agent, a contention between resources of the multiple applications of the configurable environment based on the configuration parameter's relationship as compared to test-case configuration parameter's relationships of past configurations;
querying, by the generative AI agent, a large language model (LLM) for a prefix identification;
constructing, by the generative AI agent, a resource name including the prefix identification, an application name, and one of the one or more related secret entities; and
integrating, by the generative AI agent, the resource name into a configuration setting of the property file.

2. The method of claim 1 further comprising scanning the application for personal identifiable information including a password and masking the personal identifiable information.

3. The method of claim 1 further comprising scanning the application for personal identifiable information including an API key and masking the personal identifiable information.

4. The method of claim 3 further comprising updating the property file with the masked personal identifiable information.

5. The method of claim 1 further comprising triggering a secrets manager to initiate a multithreaded secret fetch and performing an expiration check on one or more secrets returned from the multithreaded secret fetch.

6. The method of claim 1 further comprising triggering a secrets manager to initiate a multithreaded secret fetch and performing an integrity validation on one or more secrets returned from the multithreaded secret fetch.

7. The method of claim 1 further comprising storing the one or more secrets on a secure database once integrity is validated.

8. A method comprising:
reading, by a generative artificial intelligence (AI) agent executed by one or more processors, a property file including one or more current configurations of a configurable environment, the property file comprising one or more text entries describing multiple applications of the configurable environment and one or more related secret entities, wherein the property file includes an incorrect spelling or incorrect punctuation;
analyzing, by the generative AI agent, a configuration parameter relationship based on the property file and the configuration parameter's relationship on the application;
determining, by the generative AI agent, a security vulnerability of the multiple applications of the configurable environment based on the configuration parameter's relationship as compared to test-case configuration parameter's relationships of past configurations;
querying, by the generative AI agent, a large language model (LLM) for a prefix identification;
constructing, by the generative AI agent, a resource name including the prefix identification, an application name, and one of the one or more related secret entities; and
integrating, by the generative AI agent, the resource name into a configuration setting of the property file.

9. The method of claim 1 further comprising scanning the application for personal identifiable information including a password and masking the personal identifiable information.

10. The method of claim 1 further comprising scanning the application for personal identifiable information including an API key and masking the personal identifiable information.

11. The method of claim 3 further comprising updating the property file with the masked personal identifiable information.

12. The method of claim 1 further comprising triggering a secrets manager to initiate a multithreaded secret fetch and performing an expiration check on one or more secrets returned from the multithreaded secret fetch.

13. The method of claim 1 further comprising triggering a secrets manager to initiate a multithreaded secret fetch and performing an integrity validation on one or more secrets returned from the multithreaded secret fetch.

14. The method of claim 1 further comprising storing the one or more secrets on a secure database once integrity is validated.

15. A method comprising:
reading, by a generative artificial intelligence (AI) agent executed by one or more processors, a property file including one or more current configurations of a configurable environment, the property file comprising one or more text entries describing multiple applications of the configurable environment and one or more related secret entities, wherein the property file includes an incorrect spelling or incorrect punctuation;
analyzing, by the generative AI agent, a configuration parameter relationship based on the property file and the configuration parameter's relationship on the application;
determining, by the generative AI agent, at least two incompatible settings of the multiple applications of the configurable environment based on the configuration parameter's relationship as compared to test-case configuration parameter's relationships of past configurations;
querying, by the generative AI agent, a large language model (LLM) for a prefix identification;
constructing, by the generative AI agent, a resource name including the prefix identification, an application name, and one of the one or more related secret entities; and
integrating, by the generative AI agent, the resource name into a configuration setting of the property file.

16. The method of claim 1 further comprising scanning the application for personal identifiable information including a password and masking the personal identifiable information.

17. The method of claim 1 further comprising scanning the application for personal identifiable information including an API key and masking the personal identifiable information.

18. The method of claim 3 further comprising updating the property file with the masked personal identifiable information.

19. The method of claim 1 further comprising triggering a secrets manager to initiate a multithreaded secret fetch and performing an expiration check on one or more secrets returned from the multithreaded secret fetch.

20. The method of claim 1 further comprising triggering a secrets manager to initiate a multithreaded secret fetch and performing an integrity validation on one or more secrets returned from the multithreaded secret fetch.
